(19) United States
(12) Patent Application Publication
(10) Pub. No.: US 2024/0185117 A1
(43) Pub. Date: Jun. 6, 2024

(54) Knowledge Graph Based Modeling System for a Production Environment

(71) Applicant: S&P Global Inc., New York, NY (US)

(72) Inventors: Daniel Bennett, St Paul, MN (US); Mark Eramo, Houston, TX (US); Hamed Tabatabaie, Houston, TX (US); Huy Nguyen, Houston, TX (US); Camilo Rodriguez Cadena, Houston, TX (US)

(21) Appl. No.: 18/061,835

(22) Filed: Dec. 5, 2022

(51) Int. Cl. G06N 20/00

(52) U.S. Cl. CPC G06N 20/00

(57) ABSTRACT

A method, apparatus, system, and computer product for modeling a production environment. A computer system identifies a knowledge graph for a component in the production environment. The computer system trains a machine learning model to predict a set of attributes for the component using the knowledge graph.

### BACKGROUND INFORMATION

### 1. Field

The present disclosure relates generally to an improved computer system and in particular, to a method, apparatus, system, and computer program product for modeling components in a production environment.

### 2. Background

In a chemical engineering ecosystem, various elements interact in the ecosystem based on properties for these elements. These elements within the chemical engineering ecosystem can be, for example, refineries, equipment manufacturers, suppliers, consumers, data scientist, subject matter experts (SMEs), a chemical, a chemical family of the chemical, a chemical formula, chemical engineering processes, energy requirements to perform the chemical engineering processes, or other elements in the chemical engineering ecosystem. The properties can be, for example, chemical, physical, social, financial, and other properties.

Subject matter experts within the chemical engineering ecosystem use their knowledge of the chemical engineering industry to create and update models used to provide insight of relationships of the elements and current and forecasted market data for the chemical engineering industry. For example, the subject matter experts create and update models of the relationships of the elements and models such as supply, demand, cost, margin, price, or other market data models using spreadsheets.

Subject matter experts continually supervise the transfer of information regarding the relationships of elements using spreadsheets as models of the complex chemical engineering ecosystem. Additionally, in creating and updating models for the market data, the subject matter experts send and receive the market data to databases using the spreadsheets. Subject matter experts provide input to control the sending and receiving of the market data from the spreadsheets to the databases. In other words, the subject matter experts are constantly required to supervise the transfer of information regarding the complex chemical engineering market using spreadsheets as models.

In a complex chemical engineering ecosystem, the ecosystem can have hundreds of thousands of chemicals being manufactured and hundreds of thousands or millions of relationships and market data points. This situation results in increased time needed to create and update relationships between elements and create and update market data. The time needed to provide customers with this information can be slower than desired by the customers. Further, the time needed to acquire and process these relationships by subject matter experts can also introduce undesired delays.

As a result, the output of the relationships and market data can be out of date and less useful to customers. Therefore, it would be desirable to have a method, apparatus, system, and computer program product that take into account at least some of the issues discussed above, as well as other possible issues. For example, it would be desirable to have a method, apparatus, system, and computer program product that overcome a technical problem with acquiring, processing, and supervising data regarding relationships between elements and market data within a chemical engineering ecosystem in a manner that increases at least one of the usability or value of the data.

### SUMMARY

An embodiment of the present disclosure provides a computer implemented method that monitors a production environment. A computer system identifies a knowledge graph for a component in the production environment. The computer system trains a machine learning model to predict a set of attributes for the component using the knowledge graph.

In another embodiment of the present disclosure, a method models a production environment. A computer system identifies a set of knowledge graphs for components in a production environment. The computer system trains machine learning models to predict a set of attributes using the knowledge graphs. The computer system predicts the set of attributes for the components in the production environment using the machine learning models trained using the set of knowledge graphs.

In yet another embodiment of the present disclosure, a computer implemented method models a production environment. A computer identifies a set of attributes for prediction. The computer system predicts the set of attributes for a component in the production environment using a machine learning model to predict the set of attributes for the component using a knowledge graph.

In still another embodiment of the present disclosure, a model system comprises a computer system and a model manager in the computer system. The model manager identifies a knowledge graph for a component in a production environment. The model manager trains a machine learning model to predict a set of attributes for the component using the knowledge graph.

In yet another embodiment of the present disclosure a model system comprises a computer system and a model manager in the computer system. The model manager identifies a set of knowledge graphs for components in a production environment. The model manager trains machine learning models to predict a set of attributes using the knowledge graphs. The model manager predicts the set of attributes for the components in the production environment using the machine learning models trained using the set of knowledge graphs.

In still another embodiment of the present disclosure, a computer program product models a production environment. The computer program product comprises a computer readable storage medium having program instructions. The program instructions are executable by a computer system to cause the computer system to perform a method that identifies a knowledge graph for a component in the production environment, and trains a machine learning model to predict a set of attributes for the component using the knowledge graph.

In another embodiment of the present disclosure, a method models a production environment. The method generates a knowledge graph for a component in the production environment. The method selects a set of attributes for the component from the knowledge graph. The method determines a correlation value between attributes in the set of attributes for the component. The method selects the attributes in the set of attributes when the correlation value is within a correlation threshold. The method combines the selected attributes in the set of attributes when the correlation value is within the correlation threshold. The method repeats the determining, selecting, and combining steps for the selected attributes in the set of attributes until a number of selected attributes is within a selection threshold. The method sends the number of selected attributes as an input to a model of the production environment. The method updates the model of the production environment in response to receiving the number of selected attributes.

In yet another embodiment of the present disclosure a method trains a machine learning model to model a production environment. The method generates a knowledge graph for a component in the production environment. The method selects a set of attributes for the component from the knowledge graph. The method determines a correlation value between attributes in the set of attributes for the component. The method selects the attributes in the set of attributes when the correlation value is within a correlation threshold. The method combines the selected attributes in the set of attributes when the correlation value is within the correlation threshold. The method repeats the determining, selecting, and combining steps for the selected attributes in the set of attributes until a number of selected attributes is within a selection threshold. The method creates a training dataset comprising the number of selected attributes from the knowledge graph. The method trains the machine learning model using the training dataset.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented in accordance with an illustrative embodiment;

FIG. 2 is a block diagram of a production environment is depicted in accordance with a production embodiment;

FIG. 3 is a block diagram illustrating training a machine learning model using a knowledge graph in accordance with an illustrative embodiment;

FIG. 4 is a block diagram of using SHAP analysis to generate a training dataset to train a machine learning model in accordance with an illustrative embodiment;

FIG. 5 a diagram of a production environment in accordance with an illustrative embodiment;

FIG. 6 a diagram of a knowledge graph of components including a dataset of a plant within a chemical production environment in accordance with an illustrative embodiment;

FIG. 7 is a diagram of a process for building a machine learning model in accordance with an illustrative embodiment;

FIG. 8 is a flowchart of a process for modeling a production environment in accordance with an illustrative embodiment;

FIG. 9 is a flowchart of a process for predicting a set of attributes for a component in a production environment in accordance with an illustrative embodiment;

FIG. 10 is a flowchart of a process for receiving an output predicting a set of attributes for a component in accordance with an illustrative embodiment;

FIG. 11 is a flowchart of a process for training a machine learning model using a knowledge graph in accordance with an illustrative embodiment;

FIG. 12 is a flowchart of a process for modeling a production environment in accordance with an illustrative embodiment;

FIG. 13 is a flowchart of a process for using selected outputs from selected machine learning models to predict a set of attributes in accordance with an illustrative embodiment;

FIG. 14 is a flowchart of a process for modeling a production environment in accordance with an illustrative embodiment;

FIG. 15 is a flowchart of a process for training a machine learning model using a knowledge graph to predict a set of attributes in accordance with an illustrative embodiment;

FIG. 16 is a flowchart of a process for predicting a set of attributes for a component using a machine learning model trained using a knowledge graph in accordance with an illustrative embodiment;

FIG. 17 is a flowchart of a process for modeling a production environment in accordance with an illustrative embodiment;

FIG. 18 is a flowchart of a process for transforming selected attributes in accordance with an illustrative embodiment;

FIG. 19 is a flowchart of a process for predicting a set of attributes for a component using a machine learning model in accordance with an illustrative embodiment;

FIG. 20 is a flowchart of a process for training a machine learning model for modeling a production environment in accordance with an illustrative embodiment;

FIG. 21 is a flowchart of a process for predicting a set of attributes for a component using a machine learning model in accordance with an illustrative embodiment; and

FIG. 22 is a block diagram of a data processing system in accordance with an illustrative embodiment.

### DETAILED DESCRIPTION

The illustrative embodiments recognize and take into account one or more different considerations as described below. For example, the illustrative examples recognize and take into account that inefficiencies can be present when a production environment has hundreds of products being manufactured and thousands of relationships and market data points. The illustrative embodiments recognize and take into account the amount of time currently needed to collect and process information relating manufacturing products and the market data points for those products are much greater than desired. The information collected can involve the manufacture of thousands, hundreds of thousands, or more products and the relationships between those products.

The amount of time used with current techniques has inefficiencies that slows down how fast information can be provided to customers. For example, the time needed to collect and process information by subject matter experts for communicating this information to customers increases as the size and complexity of the production environment increases.

The illustrative embodiments recognize and take into account the time needed for subject matter experts to collect and analyze information related to a production environment with hundreds of products being manufactured and thousands of relationships and market data creates inefficiencies. This information can be, for example, relationship of entities, attributes of components, data from refineries, data from models and databases, or other information related to the production environment.

As the production environment increases in size and complexity, the time needed by subject matter experts to collect and process this information increases. This increased time increases the time needed to send this information to customers. As a result, this information can be out of date or less useful to customers.

Further, the illustrative embodiments recognize and take into account that accuracy can be reduced in making predictions related to the production environment when the production environment has hundreds of products being manufactured and thousands of relationships and market data points. The illustrative embodiments also recognize and take into account providing customers with explanations and insights of these predictions are difficult using current modeling techniques such as using spreadsheets by subject matter experts.

For example, the illustrative embodiments recognize and take into account subject matter experts in the production environment need time to collect and process information relating to the production environment to make accurate predictions to customers. This information can be, for example, relationship of entities, attributes of components, data from refineries, data from models and databases, or other information related to the production environment.

Currently, collecting and processing this information is a manual process that includes the subject matter experts modeling this information by generating and updating spreadsheets. When the production environment increases in size and complexity, the amount of information that needs to be collected, processed, and monitored by subject matter experts increases. This increased time makes predictions about this information is more difficult and time consuming for these subject matter experts.

Further, providing customers with explanations and insights of the predictions can be difficult using modeling techniques such as spreadsheets. As a result, providing accurate predictions and explanations and insights of the predictions to customers is reduced and becomes more difficult as the size and complexity of the production environment increase.

In the illustrative examples, a model manager collects and processes data related to a production environment to select attributes with increased accuracy. Further, the model manager uses the data and a correlation analysis on attributes of components in knowledge graphs of the production environment to select training attributes to create training datasets to train a machine learning model to generate and communicate predictions relating to the production environment to users.

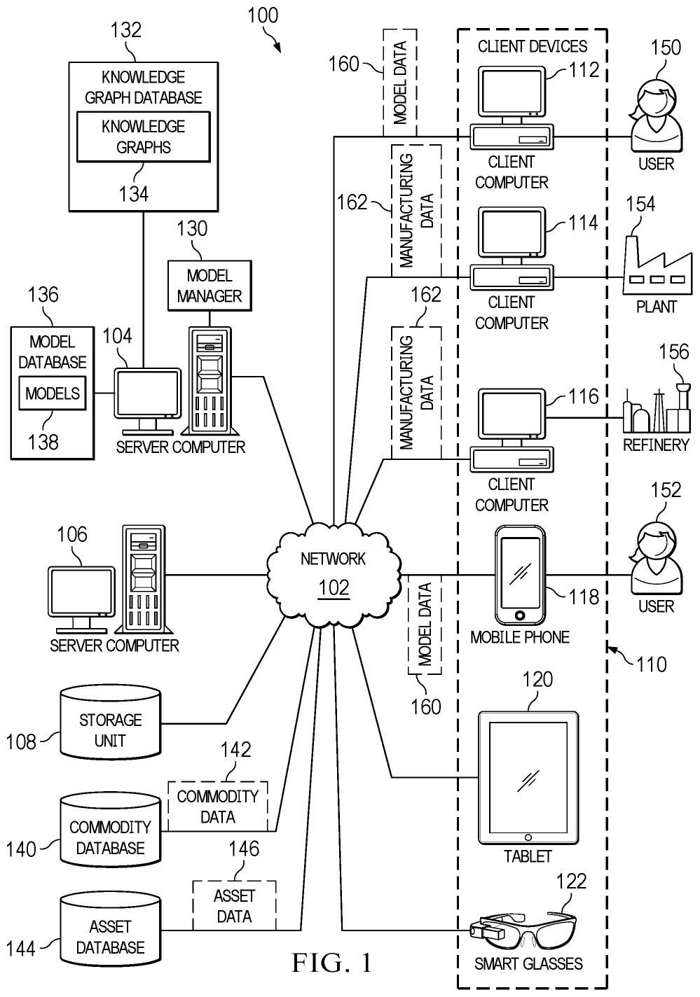

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables. In some examples, network 102 can be a wireless network.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as, mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IOT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program instructions located in network data processing system 100 can be stored on a computer-recordable storage medium and downloaded to a data processing system or other device for use. For example, program instructions can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, “a number of” when used with reference to items, means one or more items. For example, “a number of different types of networks” is one or more different types of networks.

In this illustrative example, a number of client devices 110, asset database 144, and commodity database 140 can communicate with model manager 130 located on server computer 104 over network 102. In this illustrative example, model manager 130 can use communications between client devices 110 and model manager 130 to select attributes for components within a production environment. Components can be a refinery, a manufacturing plant, equipment, and other physical structures. Attributes of the components can be a number of different forms. For example, attributes can be selected from one of power, energy use, a raw material, an amount of the raw material, an efficiency, a conversion ratio, yield, quality, price, demand, equipment outages, or other suitable attribute.

Model manager 130 can also use these communications to generate, update, and store models 138 in model database 136. For example, model manager 130 can generate, update, and store supply, demand, trade, price, and other models related to the production environment in model database 136.

In another example, model manager 130 can use these communications with client devices 110 to transmit predictions relating to the production environment to at least one of user 150 on client computer 112 and user 152 on mobile phone 118 over network 102. For example, these predictions can include predictions of at least one of attributes, supply, demand, trade, price, or other information relating to the production environment. In this example, model manager 130 generates these predictions using inputs from client devices 110 and data stored in asset database 144 and commodity database 140.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In this illustrative example, data stored in asset database 144 can include asset data 146 and data stored in commodity database 140 can include commodity data. Asset data 146 includes at least one of equipment outage data, equipment capacity, or other data related to assets. Commodity data 142 includes at least one of commodity supply, commodity demand, or other commodity information.

With this depicted example, inputs can be data relating to the production environment. For example, the data can include asset data 146 in asset database 144 and commodity data 142 in commodity database 140. Data can also include, for example, attributes of components and sensor data from components such as plant 154. In a further example, data can include recommendations from one or more subject matter experts, assumptions made by at least one of user 150 and user 152, and other inputs. Model manager 130 can use these inputs to generate predictions relating to the production environment.

Model manager 130 can also use these inputs to train a set of machine learning models. As used herein, a “set of” when used with reference items means one or more items. For example, a set of machine learning models is one or more machine learning models.

In this example, model manager 130 receives these inputs and selects a set of attributes for at least one component in the production environment. For example, the selected set of attributes can be selected from a conversion ratio, an efficiency, yield, energy use, and other information relating to refinery 156 in the production environment. The selected set of attributes is used by model manager 130 as training attributes to create a training dataset to train the machine learning model.

In this example, model manager 130 can also select attributes from the selected set of attributes that are more correlated in generating predictions relating to the production environment. For example, model manager 130 can determine that two selected attributes of efficiency and conversion ratio of a refinery are more correlated in making a prediction of an output of a chemical from the refinery. Model manager 130 can also determine these two attributes and an attribute of the location of the refinery are less correlated. In response to these determinations, model manager 130 selects efficiency and conversion ratio of the refinery as attributes and does not select the location of the refinery as an attribute.

In this example, model manager 130 can send the selected attributes from the set of selected attributes as inputs into knowledge graphs 134 stored in knowledge graph database 132. In response to knowledge graphs 134 receiving selected attributes from model manager 130, knowledge graphs 134 can output attributes to model manager 130. In this example, model manager 130 uses these outputs to create additional training datasets to train the set of machine learning models.

In this example, user 150 on client computer 112 and user 152 on mobile phone 118 in client devices 110 can communicate model data 160 with model manager 130 located on server computer 104 over network 102. Model data 160 can be predictions by model manager 130 relating to at least one of supply, demand, trade, price, quality, or other information relating to the production environment. Model data 160 can also be recommendations by at least of user 150 and user 152 in response to the predictions made by model manager 130. In this example, user 150 and user 152 can be customers, subject matter experts, data scientist, or other entities.

In another example, client computer 114 in client devices 110 located at or in communication with plant 154 communicates manufacturing data 162 to model manager 130 located on server computer 104 over network 102. Manufacturing data 162 can be, for example, sensor data from a number of sensors located at or in communication with plant 154 that detect attributes of plant 154. For example, sensors can detect various attributes including temperature, pressure, energy use, capacity, and other attributes of plant 154.

As another example, client computer 116 in client devices 110 located at or in communication with refinery 156 can communicate manufacturing data 162 to model manager 130 located on server computer 104 over network 102. In this example, manufacturing data 162 can include capacity, global positioning system (GPS) location, physical address, and other information related to refinery 156.

In another example, at least one of tablet computer 120 and smart glasses 122 in client devices 110 can be used by a user or can be located at or in communication with a component that communicates at least one of model data 160 or manufacturing data 162 to model manager 130 located on server computer 104 over network 102.

In this example, model manager 130 collects data related to a production environment. For example, the collected data can include sensor data for a set of components such as a refinery or a plant, input from a number of subject matter experts, input from a number of customers, data from models, and other data related to the production environment. The data from models can be, for example, pricing models, supply and demand models, and other suitable types of models.

Model manager 130 can process this collected data to select attributes with increased accuracy as compared to using other techniques for selecting attributes. Further, model manager 130 can use the collected data and a correlation analysis of the attributes to select training attributes to create training data to train a machine learning model. Model manager 130 can also use the collected data to generate and communicate predictions relating to at least one of supply, demand, trade, price, and other information to users relating to the production environment.

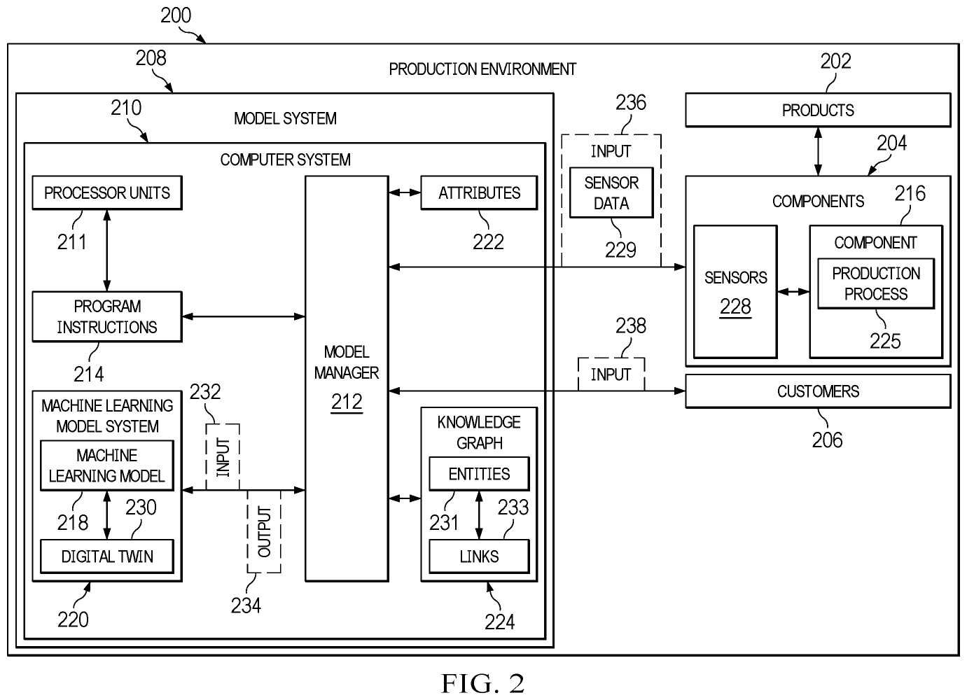

With reference now to FIG. 2, a block diagram of a production environment is depicted in accordance with a production embodiment. In this illustrative example, production environment 200 includes components that can be implemented in hardware such as the hardware shown in network data processing system 100 in FIG. 1.

In production environment 200, products 202 can be produced by components 204 in production environment 200. Products 202 can be manufactured, generated, refined, extracted, mined, or otherwise produced. Components 204 can take a number of different forms. For example, components 204 can be selected from at least one of a production facility, a manufacturing facility, a chemical plant, a refinery, an oil well, an integrated circuit manufacturing plant, a chemical refinery, a petroleum refinery, a power plant, an oil well, a gas well, a chip fabrication plant, an aircraft manufacturing facility, or other suitable types of components that can produce products 202.

In this illustrative example, customers 206 can analyze a set of components 204 or the market in which components 204 are located. This analysis may include obtaining predictions relating to at least one of supply, demand, trade, price, and other information.

Model system 208 can provide information to customers 206. In this illustrative example, model system 208 comprises computer system 210 and model manager 212. Model manager 212 is located in computer system 210.

Model manager 212 can be implemented in software, hardware, firmware or a combination thereof. When software is used, the operations performed by computer system 210 can be implemented in program code configured to run on hardware, such as a processor unit. When firmware is used, the operations performed by model manager 212 can be implemented in program code and data and stored in persistent memory to run on a processor unit. When hardware is employed, the hardware may include circuits that operate to perform the operations in model manager 212.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 210 is a physical hardware system and includes a number of data processing systems. When more than one data processing system is present computer system 210, those data processing systems are in communication with each other using a communications medium. The communications medium may be a network. The data processing systems may be selected from at least one of a computer, a server computer, a tablet, or some other suitable data processing system.

As depicted, computer system 210 includes a number of processor units 211 that are capable of executing program instructions 214 implementing processes in the illustrative examples. As used herein, a processor unit in the number of processor units 211 is a hardware device and is comprised of hardware circuits such as those on an integrated circuit that respond and process instructions and program code that operate a computer.

When a number of processor units 211 execute program instructions 214 for a process, the number of processor units 211 is one or more processor units that can be on the same computer or on different computers. In other words, the process can be distributed between processor units on the same or different computers in a computer system. Further, the number of processor units 211 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

In the illustrative example, model manager 212 can predict a set of attributes for component 216 in components 204 in production environment 200 using machine learning model 218 in machine learning model system 220 trained to predict the set of attributes 222 using knowledge graph 224. In one illustrative example, knowledge graph 224 can be for production process 225 in component 216.

A machine learning model is a type of artificial intelligence model that can learn without being explicitly programmed. A machine learning model can learn based training data input into the machine learning model. The machine learning model can learn using various types of machine learning algorithms. The machine learning algorithms include at least one of a supervised learning, and unsupervised learning, a feature learning, a sparse dictionary learning, an anomaly detection, a reinforcement learning, a recommendation learning, or other types of learning algorithms. Examples of machine learning models include an artificial neural network, a convolutional neural network, a decision tree, a support vector machine, a regression machine learning model, a classification machine learning model, a random forest learning model, a Bayesian network, a genetic algorithm, and other types of models. These machine learning models can be trained using data and process additional data to provide a desired output.

Attributes 222 can take a number of different forms. For example, attributes 222 can be selected from at least one of power, a raw material, an amount of raw material, efficiency, a conversion ratio, yield, yield quality, quality, price, demand, energy use, or other suitable attributes.

This prediction can be performed through inputs to machine learning model 218 that results in predicting the set of attributes 222. These inputs can be received any number of different ways. For example, input 238 can be received from customers 206. Input 238 can be, for example, values for other attributes other than the set of attributes 222 being predicted for component 216 by machine learning model 218.

For example, the set of attributes 222 predicted can be the amount of a chemical that can be refined in a period of time such as a week, and component 216 can be a chemical refinery. With this example, input 238 can be the amount of raw material and the amount of energy.

In another illustrative example, model manager 212 can receive input 236 from component 216 in the form of sensor data 229. Sensor data 229 can be generated by a set of sensors 228 for component 216. The set of sensors 228 can be located in a location selected from at least one of in component 216, on component 216, or in the environment around component 216.

Sensor data 229 can be sent in response to an event. The event can be a periodic event or a nonperiodic event. For example, a periodic event can be a request from a customer for a prediction by machine learning model 218. Another nonperiodic event can be detecting a change in component 216.

A periodic event can be the expiration of the period of time such as a week, a day, five hours, three minutes, or some other period of time. The period of time can be sufficiently short such that sensor data 229 is considered to be sent continuously as sensor data is generated by component 216. In some illustrative examples, this sending of sensor data can be in real time in which sensor data 229 is sent as quickly as possible without any intentional delay when sensor data 229 is generated by sensors 228 in component 216. With sensor data 229 being sent in real time, machine learning model 218 can be digital twin 230 of component 216.

For example, model manager 212 can receive sensor data 229 from component 216 in production environment 200. Model manager 212 can send sensor data 229 as input 232 to machine learning model 218. In response, model manager 212 can receive output 234 predicting the set of attributes 222 for component 216.

In one illustrative example, the prediction of the set of attributes 222 made by machine learning model 218 operating as digital twin 230 can be a prediction of the actual attributes in component 216 based on sensor data 229. For example, output 234 of the set of attributes 222 can be a prediction of temperature, pressure, energy use, and amount of refined product. This prediction predicts the actual temperature, pressure, energy use, and amount of refined product in component 216.

Additionally, the prediction of set of attributes 222 can also be for future outputs from component 216 Future attributes be made based on input 238 from a number of customers 206.

In this illustrative example, machine learning model 218 can be trained to predict a set of attributes 222 for component 216. For example, knowledge graph 224 for component 216 in production environment 200 can be identified for use in training machine learning model 218.

Knowledge graph 224 is a graph structure data model of entities 231 and links 233 between entities 231. In this illustrative example, entities 231 can take a number of different forms. For example, entities 231 can be selected from at least one of an object, a piece of equipment, a tool, a chemical equation, a process, and input material, a product, or some other suitable entity. Links 233 describe the relationship between entities 231.

For example, if knowledge graph 224 is a chemical process in a refinery, knowledge graph 224 can describe chemical processes performed by the equipment in the refinery, input such as energy and feedstocks, and outputs such as chemical products.

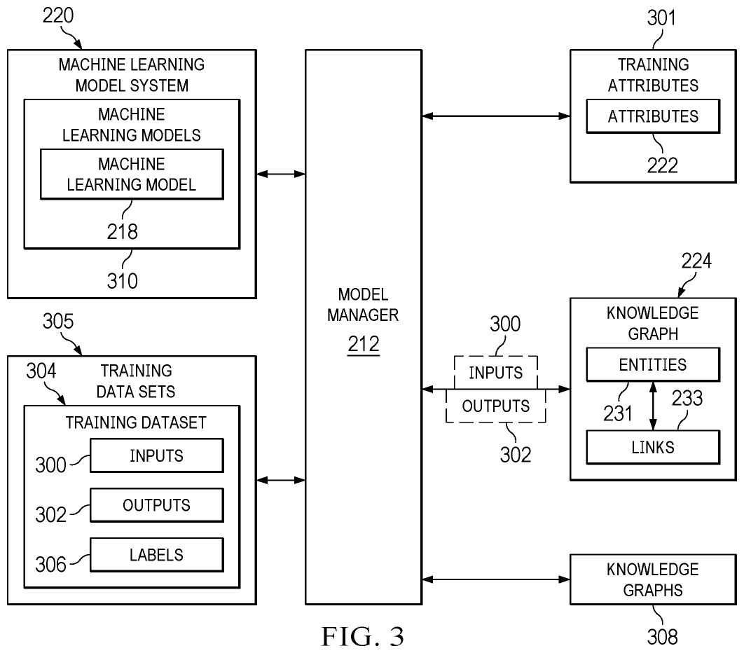

Turning next to FIG. 3, a block diagram illustrating training a machine learning model using a knowledge graph is depicted in accordance with an illustrative embodiment. In the illustrative examples, the same reference numeral may be used in more than one figure. This reuse of a reference numeral in different figures represents the same element in the different figures.

In this illustrative example, model manager 212 selects the set of attributes 222. The set of attributes 222 selected are attributes 222 for which predictions are desired to be made by machine learning model 218.

Model manager 212 can select the set of attributes 222 any number of different ways. For example, user input can be received selecting a number of attributes in the set of attributes 222. In other illustrative examples, model manager 212 can use another model or knowledge base to select what attributes are needed most or desirable to customers.

Additionally, in this illustrative example, model manager 212 selects training attributes 301. Training attributes 301 are used to create training dataset 304 to train machine learning model 218. In this depicted example, training attributes 301 can include the set of attributes 222 that is to be predicted by machine learning model 218.

In this example, model manager 212 selects training attributes 301 in a manner to increase the accuracy in which the set of attributes 222 can be predicted by machine learning model 218. For example, model manager 212 can select the set of attributes 222 in a number of different ways. For example, model manager 212 can receive input from a number of subject matter experts to select training attributes 301.

In another illustrative example, model manager 212 can use a model or analysis system to select training attributes 301. For example, model manager 212 can use an analysis system that implements a SHapley Additive explanations (SHAP) analysis to identify the set of attributes 222. This type of analysis can be used by model manager 212 to determine the most relevant attributes for the set of attributes 222. For example, attributes for a liquid can be viscosity, temperature, color, or other attributes. Model manager 212 can use a SHAP analysis to determine which ones of these attributes contribute to making predictions.

In this illustrative example, model manager 212 sends inputs 300 into knowledge graph 224 for component 216 in production environment 200. Model manager 212 receives outputs 302 for the set of attributes 222 generated in response to sending inputs 300 into knowledge graph 224. Model manager 212 creates training dataset 304 comprising inputs 300 and outputs 302 for the set of attributes 222. Additionally, labels 306 can also be added to training dataset 304 for at least one of inputs 300 or outputs 302.

In some illustrative examples, knowledge graph 224 is a knowledge graph in knowledge graphs 308. Training dataset 304 can also include inputs and outputs from other knowledge graphs in knowledge graphs 308 in addition to knowledge graph 224. In other words, the training of machine learning model 218 can be formed using training dataset 304 created from multiple knowledge graphs. For example, knowledge graph 224 may be for a first chemical process in component 216 while another knowledge graph can be for a second chemical process in component 216. Both of these knowledge graphs can be used to create training dataset 304 such that machine learning model 218 can predict a set of attributes 222 for component 216.

Model manager 212 trains machine learning model 218 using training dataset 304. After training, machine learning model 218 can be tested and verified as to the accuracy in predicting the set of attributes 222.

In this illustrative example, model manager 212 can perform training for other machine learning models in machine learning models 310 in addition to machine learning model 218. For example, machine learning model 218 can be one machine learning model in machine learning models 310 that can be trained by model manager 212 to predict attributes 222 for component 216. Model manager 212 can also train additional machine learning models in machine learning models 310 to predict the set of attributes 222.

The training of other machine learning models can involve using other knowledge graphs in knowledge graphs 308 in addition to or in place of knowledge graph 224.

Model manager 212 can also train additional machine learning models in machine learning models 310 to predict the set of attributes 222. For example, model manager 212 create training data sets 305 in addition to training dataset 304 to train machine learning models 310 in machine learning model system 220 to predict the set of set of attributes 222.

For example, 2000 or 5000 of machine learning models 310 can be trained using inputs and outputs for different selections of training attributes 301, different labels, or different types of machine learning models. In other words, machine learning model 218 and machine learning models 310 can be the same or different types of machine learning models. When different types of machine learning models are used, the same or different type of training data set can be used to train these different types of machine learning models.

Model manager 212 can select the machine learning model in machine learning models 310 that provides the most accurate prediction of the set of attributes 222. This type of training can be referred to as hyper tuning.

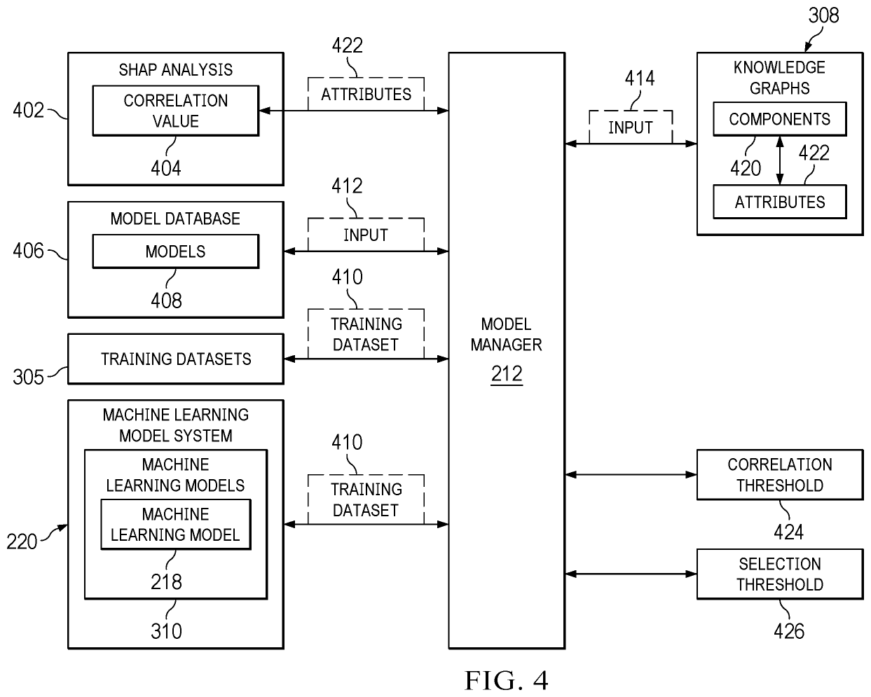

Turning next to FIG. 4, a block diagram of using SHAP analysis to generate a training dataset to train a machine learning model is depicted in accordance with an illustrative embodiment. In this illustrative example, model manager 212 selects the set of attributes 422 for components 420 from knowledge graphs 308. Model manager 212 further selects attributes in the set of attributes 422 for which predictions are desired to be made by machine learning model 218 in machine learning models 310 in machine learning model system 220.

In this illustrative example, model manager 212 can select the set of attributes 422 in a number of different ways. For example, user input can be received selecting a number of the set of attributes 422. In other illustrative examples, model manager 212 can use another model or knowledge base to select what attributes are needed most or desirable to customers.

In this example, model manager 212 can use a model or analysis system to determine correlation value 404 between attributes in the selected set of attributes 422. For example, model manager 212 can perform a SHapley Additive explanations (SHAP) analysis to determine correlation value 404 between attributes in the selected set of attributes 422. In other words, this type of analysis can be used by model manager 212 to determine which attributes in the selected set of attributes 422 are more or less correlated.

In response to receiving correlation value 404, model manager 212 can select attributes in the selected set of attributes 422 based on correlation value 404. For example, model manager 212 can select attributes in the selected set of attributes 422 when correlation value 404 is within correlation threshold 424. In the depicted example, correlation threshold 424 can be determined through experimental testing, simulations, and other techniques. The selected attributes in the selected set of attributes 422 are attributes for which predictions are desired to be made by machine learning model 218 in machine learning models 310 in machine learning model system 220.

In an illustrative example, model manager 212 selects three attributes used in the production of a chemical of (1) a conversion ratio and (2) a required energy input during the distillation process and (3) a location of a refinery performing the distillation process. Model manager 212 uses SHAP analysis 402 to generate correlation value 404 between each of these attributes.

In response to receiving correlation value 404 from SHAP analysis 402, model manager 212 can determine which of these attributes are correlated. For example, the SHAP analysis generates a correlation value of 2 for the attributes of conversion ratio and required energy input and a correlation value of 0.1 for the attributes of conversion ratio and location of refinery. Model manager 212 determines the correlation value of 2 is within correlation threshold 424 and the correlation value of 0.1 is outside correlation threshold 424 in response to receiving these correlation values.

Model manager 212 selects the attributes in the set of selected attributes in response to determining which attributes have correlation values that are within correlation threshold 424. In this example, model manager 212 combines the selected attributes to form another set of selected attributes.

As depicted, model manager 212 repeats determining a correlation value of attributes in the another set of selected attributes, selecting the attributes having a correlation value within correlation threshold 424, and combining these selected attributes until a number of selected attributes is within selection threshold 426. In the depicted example, selection threshold 426 can be determined through experimental testing, simulations, and other techniques to optimize the number of attributes selected.

For example, optimization of the number of selected attributes can be in the form of reducing the number of selected attributes until the remaining attributes are correlated within a tolerance. The tolerance can indicate an amount of correlation that is acceptable for the number of selected attributes. In this depicted example, the tolerance can be determined by subject matter experts, testing, simulations, and other techniques or sources. For example, the tolerance can be determined from SHAP values indicating the number of selected attributes contribute to making a prediction. In another example, the tolerance can be determined by subject matter experts indicating that further selection of the number of attributes is inefficient.

In this illustrative example, model manager 212 can send the number of selected attributes as input 412 to models 408 in model database 406. In this example, models 408 can be an example of models 138 in FIG. 1. In response to receiving input 412, models 408 can be generated or updated by model manager 212.

In another illustrative example, model manager 212 can send a set of selected attributes as input 414 to a set of knowledge graphs 308. In response to receiving input 414, the set of knowledge graphs 308 can generate and output a number of attributes 422 for a number of components 420 in the set of knowledge graphs 308.

As depicted, model manager 212 receives the number of attributes 422 for the number of components 420 in the set of knowledge graphs 308. Model manager creates training datasets 410 for the number of attributes 422 for the number of components 420 in the set of knowledge graphs 308. Model manager 212 uses training dataset to train a set of machine learning models 310 in machine learning model system 220.

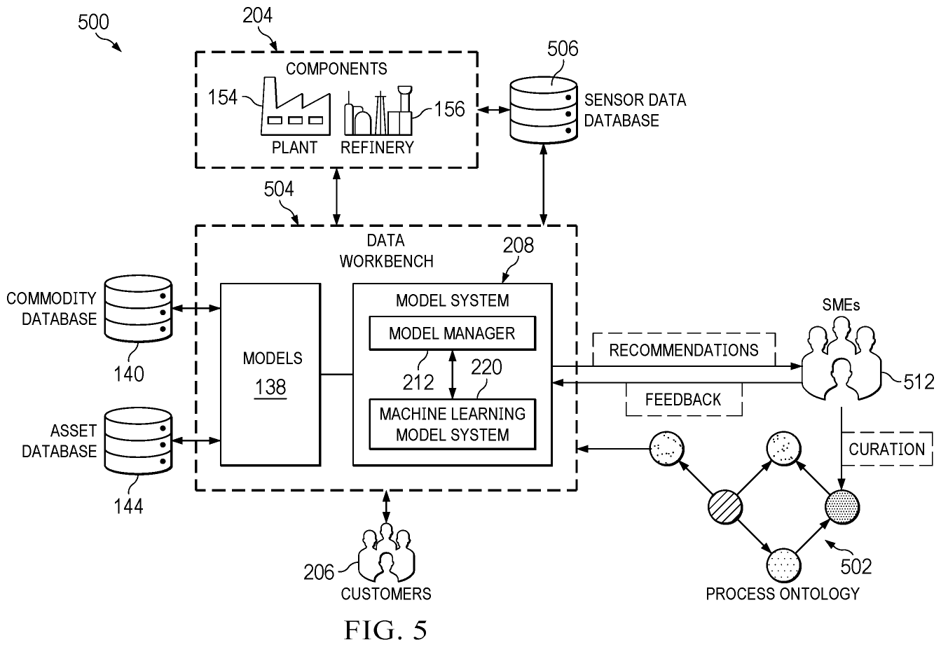

With reference to FIG. 5, a diagram of a production environment is depicted in accordance with an illustrative embodiment. In this illustrative example, production environment 500 can be implemented in production environment 200 in FIG. 2. Production environment 500 can be an example of a chemical engineering ontology environment.

Production environment 500 can comprise a number of different components 204 to produce products 202. In this depicted example, components 204 comprise plant 154 and refinery 156 to produce products 202. Products 202 can be manufactured, generated, refined, extracted, mined, or otherwise produced in production environment 500. In this example, products can be chemical compounds.

In this example, production environment 500 includes commodity database 140. Commodity database 140 is a repository for storing data about commodities used in production environment 500. In this example, commodities can be common chemicals that are produced in bulk and that can be utilized to produce a variety of other chemicals. For example, commodity pricing database can store the price of feedstock used to manufacture chemicals such as paraxylene (P-Xylene).

As depicted in the illustrative example, production environment further includes asset database. Asset database 144 is a repository for storing data about assets and outages. Asset data can include data pertaining to physical equipment, tools, or property used in the manufacturing of chemicals. For example, asset data can include data about equipment at a factory, parts, production lines, plant buildings, or other physical equipment, tools, or property used for producing chemicals. Outage data is data about a period of time when an asset is off-line in the chemical engineering process. In other words, outage data is data about when equipment at a factory, parts, production lines, plant buildings, or other physical equipment, tools, or property are unavailable during the chemical engineering process.

In this example, as depicted process ontology 502 is present in production environment 500. In this example, process ontology 502 defines the properties and relationships between the data and entities within production environment 500. For example, process ontology 502 can define the properties and relationships between components 204, commodity database 140, asset database 144, data workbench 504, sensor data database 506, and other data and entities within production environment 500.

In this example, subject matter experts 512 curate process ontology 502. Curation of process ontology 502 by subject matter experts 512 can include updating the data used in production environment 500 to produce products. For example, subject matter experts 512 can curate process ontology 502 by updating a capacity of plant 154, asset data in asset database 144, commodity pricing in commodity database 140, the relationship between entities, and other properties, data, and relationships in process ontology used in production environment 500 to produce products.

As depicted in this example, production environment 500 also includes data workbench 504. Data workbench 504 includes a number of different components. As depicted, data workbench 504 includes model system 208, model manager 212, models 138, and processes that centralizes processes for data collection and normalization and model building within production environment 500.

In this example, data workbench 504 provides operates as an interface to clients. For example, clients can be customers 206. These customers can use data workbench 504 to perform actions such as data exploration, cleaning, enrichment, modelling, and insights including commodity insights within production environment 500.

For example, as depicted data workbench 504 integrates inputs within production environment 500 to generate, update, and store models 138 by model manager 212 within the data workbench 504. These inputs can include data from commodity database 140, asset database 144, sensor data database 506, components 204, machine learning model system 220, customers 206, process ontology 502, and other data related to production environment 500. Models 138 can include supply, demand, trade, cost, margin, pricing models, or other statistical models in data workbench 504.

In this example, data workbench 504 communicates information related to production environment 500 with customers 206. For example, the information can be current market dynamics, future supply-demand-trade, and future cost-margin-price related to production environment 500. This information can also be predictions by model manager 212 in model system 208 relating to components 204 and predictions for models 138 relating to at least one of supply, demand, trade, price, quality, and other information relating to the production environment.

This information can be communicated to customers 206 in response to an event. The event can be a periodic or a non-periodic event. For example, a non-periodic event can be a request from customers 206 to analyze this information. Another non-periodic event could be a customer in customers 206 inputting capacities and equipment of a new or an existing plant and submitting a request to data workbench 504 to simulate supply, demand, trade, price, quality, and other information relating to the new or existing plant. A periodic event can be data workbench 504 monitoring production environment 500 and sending a communication to customers 206 at the expiration of a period of time such as a week, a day, five hours, three minutes, or some other period of time each time a change is detected in production environment 500. The communication of the information from data workbench 504 to customers 206 can be in the form of products such as commercial applications operating on computer systems for use by customers or other methods of communication of data.

In this illustrative example, a number of customers 206, components 204, machine learning model system 220, sensor data database 506, asset database 144, and commodity database 140 can be inputs to model manager 212 in model system 208 in data workbench 504. Model manager 212 can use these inputs to select attributes for components within a production environment 500. In this example, components 204 can be plant 154, refinery 156, a manufacturing plant, equipment, and other physical structures. Attributes of the components can be a number of different forms. For example, attributes can be selected from one of power, energy use, a raw material, an amount of the raw material, an efficiency, a conversion ratio, yield, quality, price, demand, equipment outages, or other suitable attribute.

Model manager 212 can also use these inputs to generate and update models 138 in data workbench 504. For example, model manager 212 can generate and update supply, demand, trade, price, and other models in data workbench 504 related to production environment 500.

Model manager 212 can also use these inputs to train a set of machine learning models in machine learning model system 220. In this example, model manager 212 receives these inputs and selects a set of attributes for at least one component in production environment 500.

For example, the selected set of attributes can be selected from a conversion ratio, an efficiency, yield, energy use, and other information relating to plant 154, refinery 156, or other components in components 204 in production environment 500. In this example, the selected set of attributes is used by model manager 212 as training attributes to create a training dataset to train the set of machine learning models in machine learning model system 220.

Machine learning model system 220 can provide recommendations to subject matter experts 512. Recommendations by machine learning model system 220 can include new production techniques, optimizations to inputs based on real-world factors such as the operating behavior of a refinery, and other recommendations related to production environment 500.

Subject matter experts 512 provide feedback to the set of machine learning models in machine learning model system 220. The feedback can include the acceptance or rejection of recommendations by the set of machine learning models. The feedback can also include data on the entities and processes within production environment 500.

For example, the feedback can include limitations of a plant within the production process such as a plant being limited to so many tons of a chemical in a month. Feedback can also include input on each of the processes to produce products 202 during each phase of the production process in production environment 500. In other words, subject matter experts provide supervised learning to the set of machine learning models in machine learning model system 220.

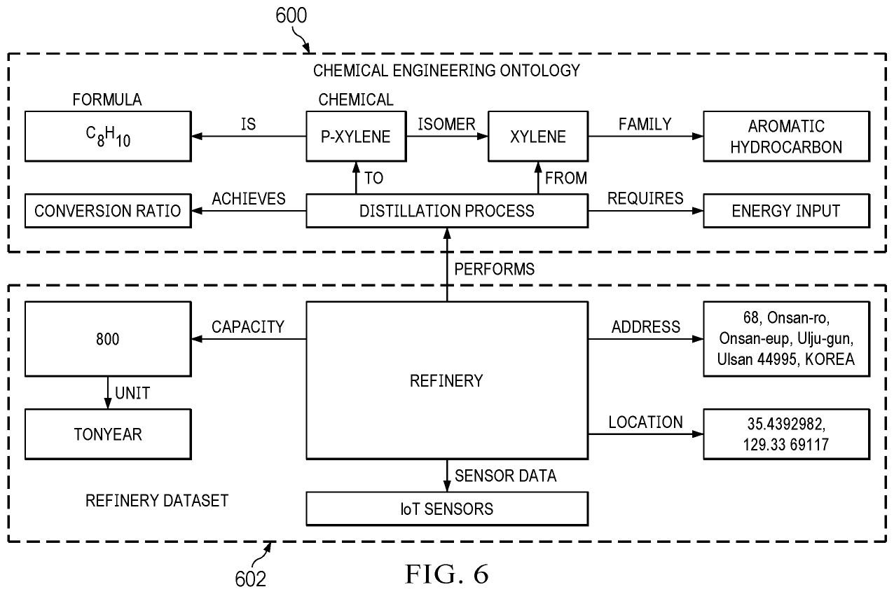

With reference now to FIG. 6, a diagram of a knowledge graph of components including a dataset of a plant within a chemical production environment is depicted in accordance with an illustrative embodiment. In the depicted example, knowledge graph 600 in this example is for a chemical production environment and provides a representation of relationships of evolving elements and their dynamic properties within the chemical production environment. The elements in the knowledge graph can also be called nodes. In this example, the elements can be examples of attributes 222 in FIG. 2. In this example, dataset 602 provides a representation of datasets for a refinery.

As depicted in this illustrative example, knowledge graph 600 provides a representation of relationships of elements within a chemical engineering ontology. The elements within knowledge graph 600 can be a formula, an isomer, a type of chemical, a chemical family of the type of chemical, a distillation process, a conversion ratio of the distillation process, and an energy input required by the distillation process, and other elements in the chemical engineering ontology.

In this illustrative example, dataset 602 provides datasets for a refinery. The elements as depicted within dataset 602 for the refinery can be a name of the refinery, a capacity of the refinery, a unit of measure for the capacity of the refinery, a GPS location of the refinery, an address of the refinery, IoT sensor data of the refinery, and other plant datasets including other manufacturing facilities and their associated datasets.

The relationship between the elements in knowledge graph 600 and dataset 602 are formed by edges. The edges provide the type of relationship formed between the elements. In this example, edges can be an example of links 233 in FIG. 2. For example, as depicted in knowledge graph 600 the relationship between the elements of “P-xylene” and “xylene” is depicted by an edge labeled as “isomer”, wherein P-xylene is an isomer of xylene. In another example, in knowledge graph 600 “distillation process” and “energy input” are elements, the relationship between these two elements can be defined by an edge labeled as “requires”, because the distillation process requires the energy input.

In this example, knowledge graph 600 defines a process implemented by a refinery dataset in dataset 602. In other words, the chemical engineering ontology in knowledge graph 600 is in relationship with the refinery dataset in dataset 602. In this example, refinery in dataset 602 implements a process defined by chemical engineering ontology in knowledge graph 600. This relationship is depicted by the edge labeled “performs” between the “distillation process” element in knowledge graph 600 and “refinery” element in dataset 602. This edge indicates that the refinery “performs” the distillation process.

In this illustrative example, knowledge graph 600 creates formalized machine readable data of the chemical production environment. In this illustrative example, chemical production environment can be an example of production environment 200 in FIG. 2. The formalized data is created by preprocessing the data before the data is outputted by knowledge graph 600. The preprocessing of the data can include processes that include techniques and rules of de-duplication, logical grouping, formatting, cleaning, curating, and other data processing techniques to preprocess data. This formalization of the data simplifies the ongoing curation process by subject matter experts 512 by preprocessing the data before the data is viewed.

The preprocessing of data also simplifies the process of training and building a set of machine learning models in machine learning model system 220.

In this example, the formalized machine readable data produced by knowledge graph 600 can be used to train the set of machine learning models in machine learning model system 220 to predict outcomes, and changes and contributions of the elements within the chemical production environment.

For example, the set of machine learning models are trained by the formalized machine readable data to output predictions and recommendations to customers 206 related to the chemical production environment. In this example, predictions can be predicting attributes 222 for components 204. Recommendations can be communications to subject matter experts 512 of a number of modifications to knowledge graph 600 by adding and removing elements and updating relationships of the elements in the knowledge graph. In this example, elements can be examples of attributes 222. For example, when more accurate or optimal energy and feedstock inputs are detected from Internet of things (IOT) data, the set of machine learning models in machine learning model system 220 can recommend to subject matter experts 512 to add the new data to the knowledge graph. The new data is an additional element in knowledge graph 600. In other words, knowledge graph 600 can dynamically add and remove edges and elements and update relationships of edges and elements for the chemical production process.

In this example, knowledge graph 600 provides formalized machine readable data of the changes in the form of a training dataset to model manager 212 in model system 208. Model manager 212 uses the training dataset from knowledge graph 600 to train machine learning model 218 in machine learning model system 220. In other words, the set of machine learning models can be trained and retrained by the formalized machine readable data from knowledge graph 600.

The illustration of knowledge graph 600 and dataset 602 are shown to illustrate one manner in which a dataset can be used with the knowledge graph. In this example, knowledge graph 600 and dataset 602 are only a small subset of information that can be present for refining xylene to obtain p-xylene in a refinery.

For example, knowledge graph 600 can include labels for each element, formulas for each chemical, taxonomic information, or other information in the production environment. Dataset 602 can include for each refinery a geospatial polygon and each process by each refinery including operating condition, equipment information, links to IoT data, or other information in the dataset of each refinery.

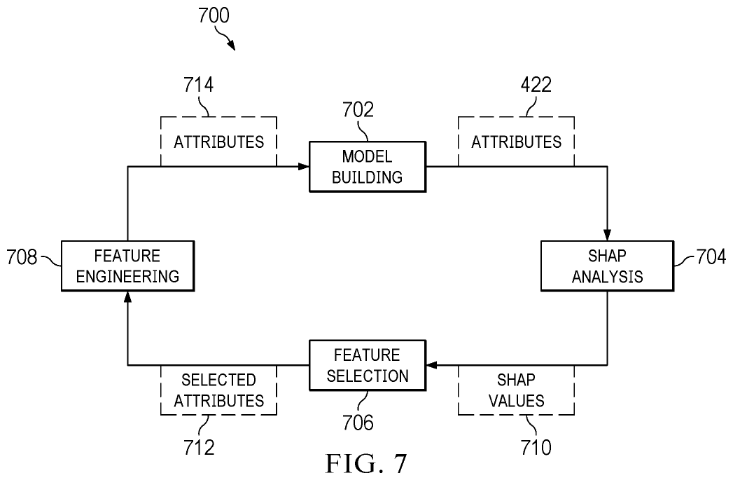

Turning next to FIG. 7, a diagram of a process for building a machine learning model is depicted in accordance with an illustrative embodiment. In this illustrative example, model building process 700 includes components that can be implemented by model manager 212 in FIG. 2.

In this illustrative example, model building process 700 includes model building 702, SHAP analysis 704, feature selection 706, and feature engineering 708. In another example, model building process 700 can include additional components. For example, model building process can include permutation feature importance analysis for feature selection 706. Permutation feature importance is a method that randomly shuffles a feature value to determine a contribution of the feature in making predictions. In other words, permutation feature analysis can determine which attributes in the set of attributes contribute to making predictions. Permutation feature importance can be used to compare SHAP values returned from SHAP analysis 704.

Model building 702 can include building data models, machine learning models, and other types of models. In this depicted example, model building 702 includes a set of attributes 422 for a set of components 420 in a set of knowledge graphs 308.

In this example, model building process 700 can include multicollinearity analysis on attributes before model building 702. Multicollinearity analysis identifies independent features that are highly correlated and removes these highly correlated features before building a model to reduce fluctuation in the model. For example, multicollinearity analysis on attributes in a set of attributes can determine these attributes are highly correlated and remove at least one of these attributes from the set of attributes before building the model from the set of attributes. The removal of features using the multicollinearity analysis can be implemented by Variable Inflation Factor (VIF), Principal Component Analysis (PCA), or other feature removal technique.

SHAP analysis 704 analyzes attributes in the set of attributes 422. This analysis can be, for example, based on which attributes in the set of attributes 422 are correlated in making predictions. This analysis can also be based on which attributes in the set of attributes contribute to making predictions. SHAP analysis 704 outputs SHAP values 710 to feature selection 706. SHAP values 710 can provide an interpretation of the contribution of the attributes in the selected set of attributes to explain the predictions.

In this example, feature selection 706 selects attributes in the set of attributes 422 based on SHAP values 710. This selection can be, for example, when SHAP values 710 exceed a threshold. This threshold can be a contribution, correlation, or other type of threshold that can be determined through experimental testing, simulations, or other techniques. In this depicted illustrative example, feature selection 706 outputs a set of selected attributes 712 from the set of attributes 714.

In this depicted example, feature engineering 708 receives the set of selected attributes 712. Feature engineering 708 determines whether to perform a set of actions on the set of selected attributes 712. Feature engineering 708 can be trained to make determinations through knowledge of subject matter experts 512, machine learning, experimental testing, simulations, and other techniques.

Feature engineering 708 performs the set of actions on the set of selected attributes in response to determining a set of actions needs to be performed. These actions can include adding, removing, updating, or other actions to perform on a number of attributes in the set of selected attributes 712.

For example, in response to determining a formula for a conversion ratio needs to be added in the selected attributes, feature engineering 708 adds the formula to the selected attributes. In another example, in response to determining that a formula needs to be updated for an attribute in the selected attributes, feature engineering 708 updates the formal for the attribute. In this illustrative example, feature engineering 708 outputs attributes 714. Attributes 714 is the set of selected attributes 712 that includes any additions, subtractions, updates, or other actions performed by feature engineering 708 on the set of selected attributes 712.

In this illustrative example, attributes 714 are received by model building 702 from feature engineering 708. Model building process 700 repeats the processes on attributes 714 using components model building 702, SHAP analysis 704, feature selection 706, and feature engineering 708. This process can be repeated until attributes 714 are within a threshold. This threshold can be, for example, a value, a determination, or other threshold.

For example, this threshold can be a change in the median absolute error from model building using SHAP values of attributes in the set of attributes. In this example, this change can be a percent change such as 3%, 5%, or some other percent change. In other words, model building occurs by selecting attributes from the set of attributes having a highest SHAP value until the change in the median absolute error is within a threshold. In this example, model building can be, for example, creating thousands of models by continuing to select attributes in the set of attributes with the next highest SHAP values to create additional models until the change in the median absolute is within the threshold.

In one illustrative example, one or more technical solutions are present that overcome a technical problem with acquiring, processing, and supervising data regarding relationships between elements and market data within a chemical engineering ecosystem in a manner that increases at least one of the usability or value of the data.

As a result, one or more technical solutions may provide a technical effect of providing data regarding relationships between elements and market data within a chemical engineering ecosystem in a manner that increases at least one of the usability or value of the data.

Additionally, one or more technical solutions may provide the ability to collect and process information relating to a production environment that is increasing in size and complexity to make accurate predictions to customers. These predictions can be relationship of entities, attributes of components, data from refineries, data from models and databases, or other information related to the production environment.

One or more technical solutions may also provide customers with explanations and insights of predictions for a production environment using modeling techniques. These modeling techniques can be training machine learning models using knowledge graphs related to the production environment.

In this manner, customers can be provided with explanation and insight of predictions relating to a production environment using these modeling techniques. As a result, customers are provided with accurate predictions and explanations and insights of the predictions even when the size and complexity of the production environment increase.

Computer system 210 can be configured to perform at least one of the steps, operations, or actions described in the different illustrative examples using software, hardware, firmware or a combination thereof. As a result, computer system 210 operates as a special purpose computer system in which model manager 212 in computer system 210 enables the collecting and processing of inputs relating to production environment 200 in a manner that provides customers 206 with accurate predictions and explanations and insights of the predictions as the size and complexity of production environment 200 increases. In particular, model manager 212 transforms computer system 210 into a special purpose computer system as compared to currently available general computer systems that do not have model manager 212.

In the illustrative example, the use of model manager 212 in computer system 210 integrates processes into a practical application by implementing a method of modeling a production environment that increases the performance of computer system 210. In other words, model manager 212 in computer system 210 is directed to a practical application of processes integrated into model manager 212 in computer system 210 that can model a production environment by identifying a number of knowledge graphs for a number of components in the production environment. In this illustrative example, model manager 212 in computer system 210 trains a number of machine learning models to predict a set of attributes for the number of components using the number of knowledge graphs that results in providing customers with accurate predictions and explanations and insights of the predictions of a production environment as the size and complexity of the production environment increase. In this manner, model manager 212 in computer system 210 provides a practical application of invention by implementing a method of modeling a production environment such that the functioning of computer system 210 is improved.

The illustration of production environment 200 and the different components in FIGS. 2-7 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

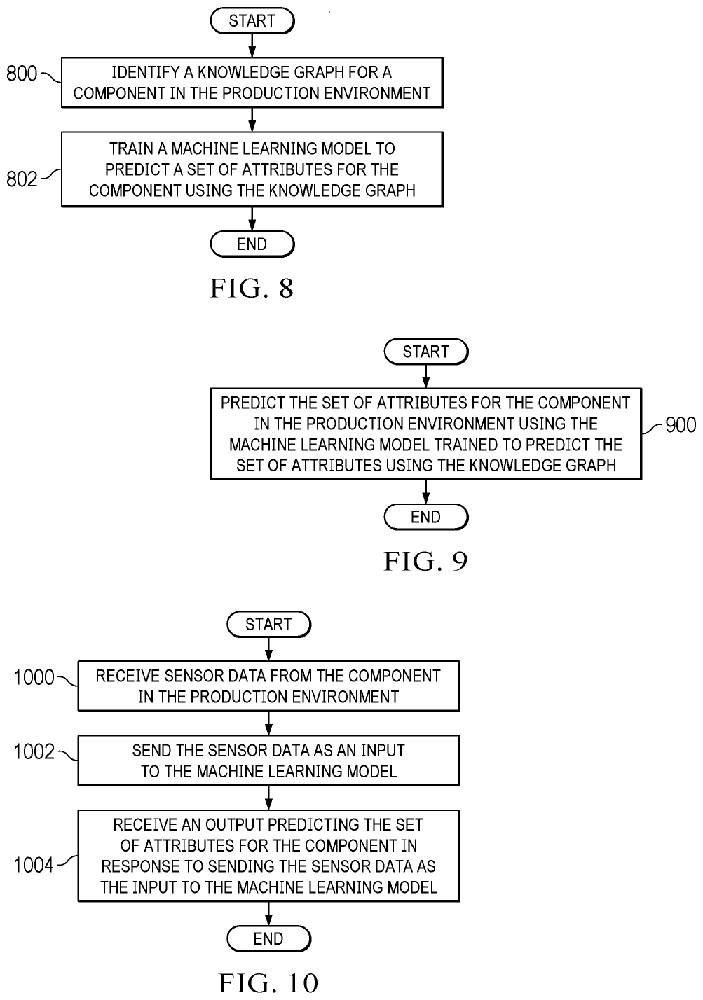

Turning next to FIG. 8, a flowchart of a process for modeling a production environment is depicted in accordance with an illustrative embodiment. The process in FIG. 8 can be implemented in hardware, software, or both. When implemented in software, the process can take the form of program code that is run by one of more processor units located in one or more hardware devices in one or more computer systems. For example, the process can be implemented in model manager 212 in computer system 210 in FIG. 2.

The process begins by identifying a knowledge graph for a component in the production environment (step 800). The process trains a machine learning model to predict a set of attributes for the component using the knowledge graph (step 802). The process terminates thereafter.

In step 802, the knowledge graph is derived from an ontology of a production process in the component. In step 804, the machine learning model can be a digital twin for the component in the production environment.

With reference to FIG. 9, a flowchart of a process for predicting a set of attributes for a component in a production environment is depicted in accordance with an illustrative embodiment. The step in the process in this figure is an example of an additional step that can be used within the steps in the process in FIG. 8. The process predicts the set of attributes for the component in the production environment using the machine learning model trained to predict the set of attributes using the knowledge graph (step 900). The process terminates thereafter.

Turning to FIG. 10, a flowchart of a process for receiving an output predicting a set of attributes for a component is depicted in accordance with an illustrative embodiment. The steps in this figure are examples of additional steps that can be used within the steps in the process in FIG. 8.

The process begins by receiving sensor data from the component in the production environment (step 1000). The process sends the sensor data as an input to the machine learning model (step 1002). The process receives an output predicting the set of attributes for the component in response to sending the sensor data as the input to the machine learning model (step 1004). The process terminates thereafter.

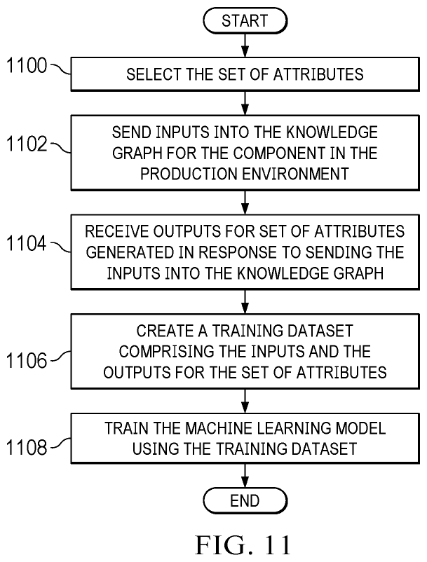

Turning next to FIG. 11, a flowchart of a process for training a machine learning model using a knowledge graph is depicted in accordance with an illustrative embodiment. The process illustrated in FIG. 11 is an example of one implementation for step 802 in FIG. 8.

The process begins by selecting the set of attributes (step 1100). The process sends inputs into the knowledge graph for the component in the production environment (step 1102). The process receives outputs for a set of attributes generated in response to sending the inputs into the knowledge graph (step 1104). The process creates a training dataset comprising the inputs and the outputs for the set of attributes (step 1106). The process trains the machine learning model using the training dataset (step 1108). The process terminates thereafter.

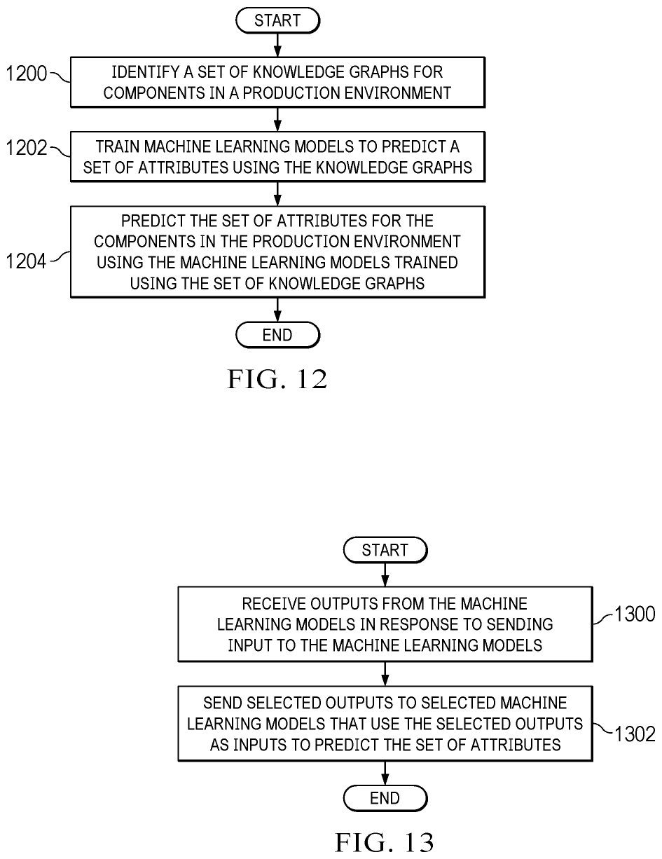

With reference to FIG. 12, a flowchart of a process for modeling a production environment is depicted in accordance with an illustrative embodiment. The process in FIG. 12 can be implemented in hardware, software, or both. When implemented in software, the process can take the form of program code that is run by one of more processor units located in one or more hardware devices in one or more computer systems. For example, the process can be implemented in model manager 212 in computer system 210 in FIG. 2.

The process begins by identifying a set of knowledge graphs for components in a production environment (step 1200). The process trains machine learning models to predict a set of attributes using the knowledge graphs (step 1202). The process predicts the set of attributes for the components in the production environment using the machine learning models trained using the set of knowledge graphs (step 1204). The process terminates thereafter.

Turning to FIG. 13, a flowchart of a process for using selected outputs from selected machine learning models to predict a set of attributes is depicted in accordance with an illustrative embodiment. The steps in this figure are examples of additional steps that can be used within the steps in the process in FIG. 12.

The process begins by receiving outputs from the machine learning models in response to sending input to the machine learning models (step 1300). The process sends selected outputs to selected machine learning models that use the selected outputs as inputs to predict the set of attributes (step 1302). The process terminates thereafter.

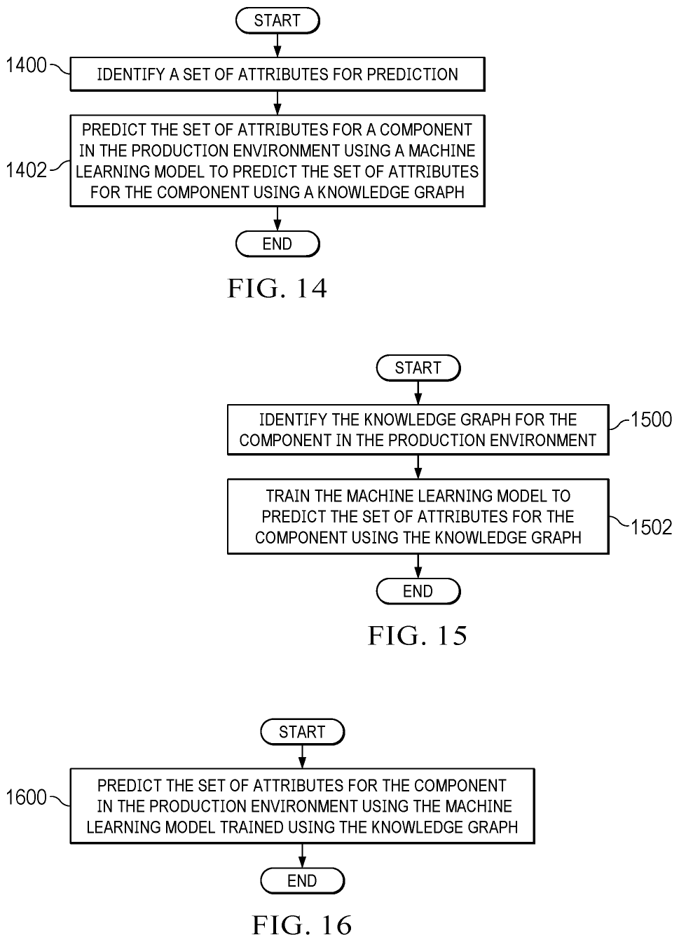

Turning next to FIG. 14, a flowchart of a process for modeling a production environment is depicted in accordance with an illustrative embodiment. The process in FIG. 14 can be implemented in hardware, software, or both. When implemented in software, the process can take the form of program code that is run by one of more processor units located in one or more hardware devices in one or more computer systems. For example, the process can be implemented in model manager 212 in computer system 210 in FIG. 2.

The process begins by identifying a set of attributes for prediction (step 1400). The process predicts the set of attributes for a component in the production environment using a machine learning model to predict the set of attributes for the component using a knowledge graph (step 1402). The process terminates thereafter.

With reference to FIG. 15, a flowchart of a process for training a machine learning model using a knowledge graph to predict a set of attributes is depicted in accordance with an illustrative embodiment. The steps in this figure are examples of additional steps that can be used within the steps in the process in FIG. 14.

The process begins by identifying the knowledge graph for the component in the production environment (step 1500). The process trains the machine learning model to predict the set of attributes for the component using the knowledge graph (step 1502). The process terminates thereafter.

Turning to FIG. 16, a flowchart of a process for predicting a set of attributes for a component using a machine learning model trained using a knowledge graph is depicted in accordance with an illustrative embodiment. The step in this figure is an example of an additional step that can be used within the steps in the process in FIG. 14. The process predicts the set of attributes for the component in the production environment using the machine learning model trained using the knowledge graph (operation 1600). The process terminates thereafter.

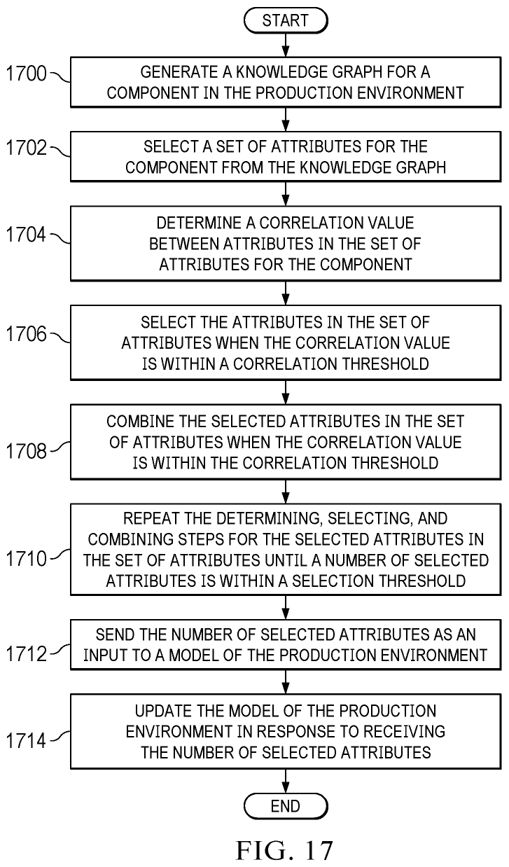

Turning next to FIG. 17, a flowchart of a process for modeling a production environment is depicted in accordance with an illustrative embodiment. The process in FIG. 17 can be implemented in hardware, software, or both. When implemented in software, the process can take the form of program code that is run by one of more processor units located in one or more hardware devices in one or more computer systems. For example, the process can be implemented in model manager 212 in computer system 210 in FIG. 2.

The process begins by generating a knowledge graph for a component in the production environment (step 1700). The process selects a set of attributes for the component from the knowledge graph (step 1702). The process determines a correlation value between attributes in the set of attributes for the component (step 1704). The process selects the attributes in the set of attributes when the correlation value is within a correlation threshold (step 1706).

The process combines the selected attributes in the set of attributes when the correlation value is within the correlation threshold (step 1708). The process repeats the determining, selecting, and combining steps for the selected attributes in the set of attributes until a number of selected attributes is within a selection threshold (step 1710). The process sends the number of selected attributes as an input to a model of the production environment (step 1712). The process updates the model of the production environment in response to receiving the number of selected attributes (step 1714). The process terminates thereafter.

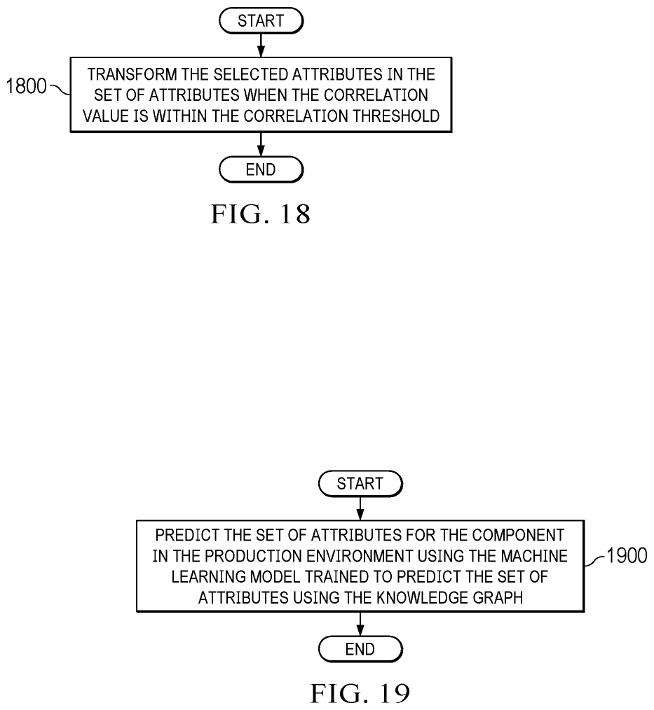

With reference to FIG. 18, a flowchart of a process for transforming selected attributes is depicted in accordance with an illustrative embodiment. The step in this figure is an example of an additional step that can be used within the steps in the process in FIG. 17. The process transforms the selected attributes in the set of attributes when the correlation value is within the correlation threshold (step 1800). The process terminates thereafter.

Turning next to FIG. 19, a flowchart of a process for predicting a set of attributes for a component using a machine learning model is depicted in accordance with an illustrative embodiment. The step in this figure is an example of an additional step that can be used within the steps in the process in FIG. 17.

The process predicts the set of attributes for the component in the production environment using the machine learning model trained to predict the set of attributes using the knowledge graph (step 1900). The process terminates thereafter.

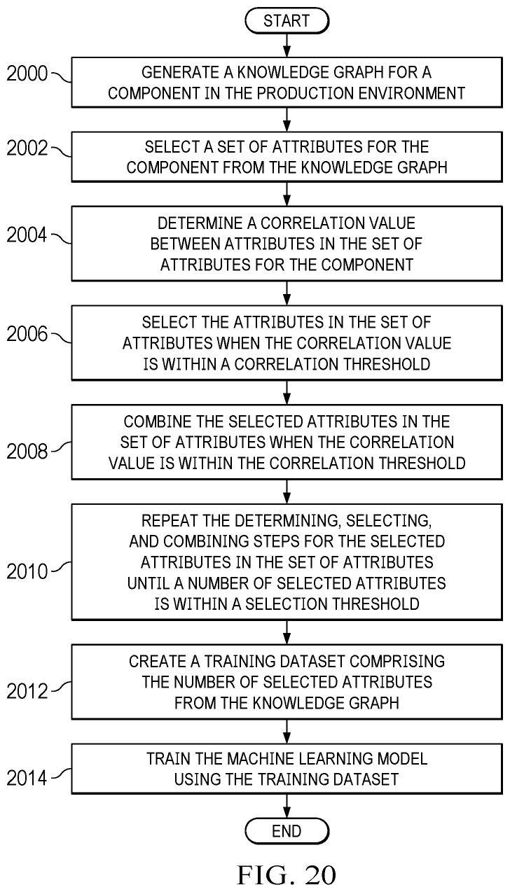

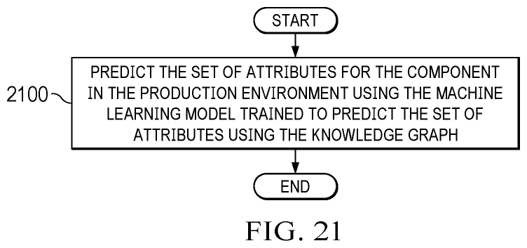

With reference to FIG. 20, a flowchart of a process for training a machine learning model for modeling a production environment is depicted in accordance with an illustrative embodiment. The process in FIG. 21 can be implemented in hardware, software, or both. When implemented in software, the process can take the form of program code that is run by one of more processor units located in one or more hardware devices in one or more computer systems. For example, the process can be implemented in model manager 212 in computer system 210 in FIG. 2.

The process begins by generating a knowledge graph for a component in the production environment (step 2000). The process selects a set of attributes for the component from the knowledge graph (step 2002). The process determines a correlation value between attributes in the set of attributes for the component (step 2004). The process selects the attributes in the set of attributes when the correlation value is within a correlation threshold (step 2006).

The process combines the selected attributes in the set of attributes when the correlation value is within the correlation threshold (step 2008). The process repeats the determining, selecting, and combining steps for the selected attributes in the set of attributes until a number of selected attributes is within a selection threshold (step 2010). The process creates a training dataset comprising the number of selected attributes from the knowledge graph (step 2012). The process trains the machine learning model using the training dataset (step 2014). The process terminates thereafter.

Turning to FIG. 21, a flowchart of a process for predicting a set of attributes for a component using a machine learning model is depicted in accordance with an illustrative embodiment. The step in this figure is an example of an additional step that can be used within the steps in the process in FIG. 20.

The process predicts the set of attributes for the component in the production environment using the machine learning model trained to predict the set of attributes using the knowledge graph (step 2100). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

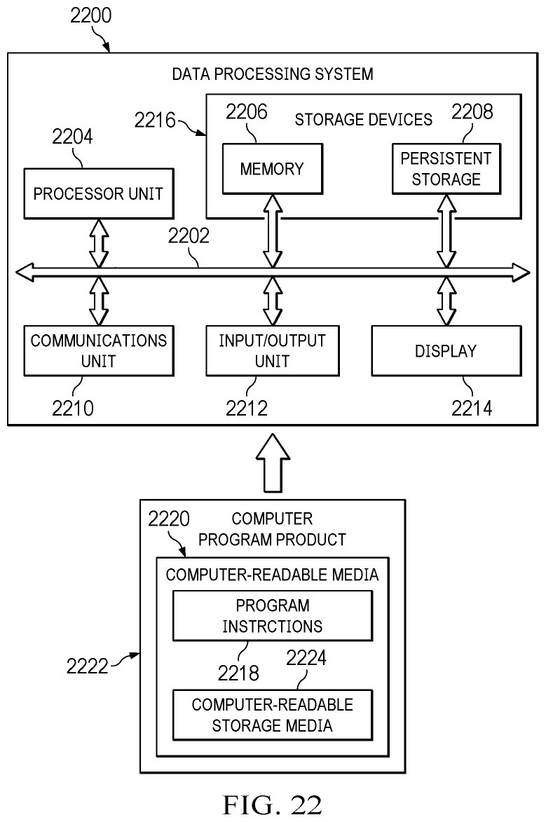

Turning now to FIG. 22, a block diagram of a data processing system is depicted in accordance with an illustrative embodiment. Data processing system 2200 can be used to implement server computer 104, server computer 106, client devices 110, in FIG. 1. Data processing system 2200 can also be used to implement computer system 210 in FIG. 2. In this illustrative example, data processing system 2200 includes communications framework 2202, which provides communications between processor unit 2204, memory 2206, persistent storage 2208, communications unit 2210, input/output (I/O) unit 2212, and display 2214. In this example, communications framework 2202 takes the form of a bus system.

Processor unit 2204 serves to execute instructions for software that can be loaded into memory 2206. Processor unit 2204 includes one or more processors. For example, processor unit 2204 can be selected from at least one of a multicore processor, a central processing unit (CPU), a graphics processing unit (GPU), a physics processing unit (PPU), a digital signal processor (DSP), a network processor, or some other suitable type of processor. Further, processor unit 2204 can may be implemented using one or more heterogeneous processor systems in which a main processor is present with secondary processors on a single chip. As another illustrative example, processor unit 2204 can be a symmetric multi-processor system containing multiple processors of the same type on a single chip.

Memory 2206 and persistent storage 2208 are examples of storage devices 2216. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 2216 may also be referred to as computer-readable storage devices in these illustrative examples. Memory 2206, in these examples, can be, for example, a random-access memory or any other suitable volatile or non-volatile storage device. Persistent storage 2208 may take various forms, depending on the particular implementation.

For example, persistent storage 2208 may contain one or more components or devices. For example, persistent storage 2208 can be a hard drive, a solid-state drive (SSD), a flash memory, a rewritable optical disk, a rewritable magnetic tape, or some combination of the above. The media used by persistent storage 2208 also can be removable. For example, a removable hard drive can be used for persistent storage 2208.

Communications unit 2210, in these illustrative examples, provides for communications with other data processing systems or devices. In these illustrative examples, communications unit 2210 is a network interface card.

Input/output unit 2212 allows for input and output of data with other devices that can be connected to data processing system 2200. For example, input/output unit 2212 may provide a connection for user input through at least one of a keyboard, a mouse, or some other suitable input device. Further, input/output unit 2212 may send output to a printer. Display 2214 provides a mechanism to display information to a user.

Instructions for at least one of the operating system, applications, or programs can be located in storage devices 2216, which are in communication with processor unit 2204 through communications framework 2202. The processes of the different embodiments can be performed by processor unit 2204 using computer-implemented instructions, which may be located in a memory, such as memory 2206.

These instructions are program instructions and are also referred to as program code, computer usable program code, or computer-readable program code that can be read and executed by a processor in processor unit 2204. The program code in the different embodiments can be embodied on different physical or computer-readable storage media, such as memory 2206 or persistent storage 2208.

Program code 2218 is located in a functional form on computer-readable media 2220 that is selectively removable and can be loaded onto or transferred to data processing system 2200 for execution by processor unit 2204. Program code 2218 and computer-readable media 2220 form computer program product 2222 in these illustrative examples. In the illustrative example, computer-readable media 2220 is computer-readable storage medium 2224.

Computer-readable storage medium 2224 is a physical or tangible storage device used to store program code 2218 rather than a medium that propagates or transmits program code 2218. Computer-readable storage medium 2224, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 2218 can be transferred to data processing system 2200 using a computer-readable signal media. The computer-readable signal media are signals and can be, for example, a propagated data signal containing program code 2218. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 2220” can be singular or plural. For example, program code 2218 can be located in computer-readable media 2220 in the form of a single storage device or system. In another example, program code 2218 can be located in computer-readable media 2220 that is distributed in multiple data processing systems. In other words, some instructions in program code 2218 can be located in one data processing system while other instructions in program code 2218 can be located in one data processing system. For example, a portion of program code 2218 can be located in computer-readable media 2220 in a server computer while another portion of program code 2218 can be located in computer-readable media 2220 located in a set of client computers.

The different components illustrated for data processing system 2200 are not meant to provide architectural limitations to the manner in which different embodiments can be implemented. The different illustrative embodiments can be implemented in a data processing system including components in addition to or in place of those illustrated for data processing system 2200. Other components shown in FIG. 22 can be varied from the illustrative examples shown. The different embodiments can be implemented using any hardware device or system capable of running program code 2218.

The description of the different illustrative embodiments has been presented for purposes of illustration and description and is not intended to be exhaustive or limited to the embodiments in the form disclosed. In some illustrative examples, one or more of the components may be incorporated in or otherwise form a portion of, another component. For example, the 2206, or portions thereof, may be incorporated in processor unit 2204 in some illustrative examples.

Thus, the illustrative examples provide a method, apparatus, system, and computer program product for modeling a production environment. In the illustrative examples, a computer system identifies a knowledge graph for a component in the production environment. This knowledge graph is used by the computer system to train a machine learning model to predict a set of attributes for the component.

In the illustrative examples, information relating to a production environment can be collected and processed to make accurate predictions to customers. The predictions can be provided to customers with explanations and insights of these predictions for a production environment using modeling techniques. In this manner, customers can be provided with accurate predictions and explanations and insights of the predictions as the size and complexity of the production environment increase.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, To the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer implemented method for modeling a production environment, the computer implemented method comprising:
identifying, by a computer system, a knowledge graph for a component in the production environment; and
training, by the computer system, a machine learning model to predict a set of attributes for the component using the knowledge graph.

2. The method of claim 1 further comprising:
predicting, by the computer system, the set of attributes for the component in the production environment using the machine learning model trained to predict the set of attributes using the knowledge graph.

3. The method of claim 1 further comprising:
receiving, by the computer system, sensor data from the component in the production environment;
sending, by the computer system, the sensor data as an input to the machine learning model; and
receiving, by the computer system, an output predicting the set of attributes for the component in response to sending the sensor data as the input to the machine learning model.

4. The method of claim 1, wherein training, by the computer system, the machine learning model using the knowledge graph comprises:
selecting, by the computer system, the set of attributes;
sending, by computer system, inputs into the knowledge graph for the component in the production environment;
receiving, by the computer system, outputs for set of attributes generated in response to sending the inputs into the knowledge graph;
creating, by the computer system, a training dataset comprising the inputs and the outputs for the set of attributes; and
training, by the computer system, the machine learning model using the training dataset.

5. The method of claim 1, wherein the knowledge graph is derived from an ontology of a production process in the component.

6. The method of claim 1, wherein the component is one of a production facility, a manufacturing facility, a chemical plant, a refinery, oil well, an integrated circuit manufacturing plant, a chemical refinery, a petroleum refinery, a power plant, an oil well, a gas well, a chip fabrication plant, and an aircraft manufacturing facility.

7. The method of claim 1, wherein the machine learning model is a digital twin for the component in the production environment.

8. A method for modeling a production environment comprising:
identifying, by a computer system, a set of knowledge graphs for components in a production environment;
training, by the computer system, machine learning models to predict a set of attributes using the knowledge graphs; and
predicting, by the computer system, the set of attributes for the components in the production environment using the machine learning models trained using the set of knowledge graphs.

9. The method of claim 8 further comprising:
receiving, by the computer system, outputs from the machine learning models in response to sending input to the machine learning models; and
sending, by the computer system, selected outputs to selected machine learning models that use the selected outputs as inputs to predict the set of attributes.

10. A computer implemented method for modeling a production environment, the computer implemented method comprising:
identifying, by a computer system, a set of attributes for prediction; and
predicting, by the computer system, the set of attributes for a component in the production environment using a machine learning model to predict the set of attributes for the component using a knowledge graph.

11. The method of claim 10 further comprising:
identifying, by the computer system, the knowledge graph for the component in the production environment; and
training, by the computer system, the machine learning model to predict the set of attributes for the component using the knowledge graph.

12. The method of claim 11 further comprising:
predicting, by the computer system, the set of attributes for the component in the production environment using the machine learning model trained using the knowledge graph.

13. A model system comprising:
a computer system;
a model manager in the computer system, wherein the model manager is configured to:
identify a knowledge graph for a component in a production environment; and
train a machine learning model to predict a set of attributes for the component using the knowledge graph.

14. The model system of claim 13, wherein the model manager is configured to:
predict the set of attributes for the component in the production environment using the machine learning model trained to predict the set of attributes using the knowledge graph.

15. The model system of claim 13, wherein the model manager is configured to:
receiving, by the computer system, sensor data from the component in the production environment;
sending, by the computer system, the sensor data as an input to the machine learning model; and
receiving, by the computer system, an output predicting the set of attributes for the component in response to sending the sensor data as the input to the machine learning model.

16. The model system of claim 13, wherein in training the machine learning model using the knowledge graph, the model manager is configured to:
select the set of attributes;
send inputs into the knowledge graph for the production environment;
receive outputs for set of attributes generated in response to sending the inputs into the knowledge graph;
create a training dataset comprising the inputs and the outputs for the set of attributes; and
train the machine learning model using the training dataset.

17. The model system of claim 13, wherein the knowledge graph is derived from an ontology of a production process in the component.

18. The model system of claim 13, wherein the component is one of a production facility, a manufacturing facility, a chemical plant, a refinery, oil well, an integrated circuit manufacturing plant, a chemical refinery, a petroleum refinery, a power plant, an oil well, a gas well, a chip fabrication plant, and an aircraft manufacturing facility.

19. The model system of claim 13, wherein the machine learning model is a digital twin for the component in the production environment.

20. A model system comprising:
a computer system;
a model manager in the computer system, wherein the model manager is configured to:
identify a set of knowledge graphs for components in a production environment;
train machine learning models to predict a set of attributes using the knowledge graphs; and
predict the set of attributes for the components in the production environment using the machine learning models trained using the set of knowledge graphs.

21. The model system of claim 20, wherein the model manager is configured to:
receive outputs from the machine learning models in response to sending input to the machine learning models; and
send selected outputs to selected machine learning models that use the selected outputs as inputs to predict the set of attributes.

22. A computer program product for modeling a production environment, the computer program product comprising a computer readable storage medium having program instructions embodied therewith, the program instructions are executable by a computer system to cause the computer system to perform a method of:
identifying, by a computer system, a knowledge graph for a component in the production environment; and
training, by the computer system, a machine learning model to predict a set of attributes for the component using the knowledge graph.

23. A computer program product for modeling a production environment, the computer program product comprising a computer readable storage medium having program instructions embodied therewith, the program instructions executable by a computer system to cause the computer system to perform a method of:
identifying, by a computer system, a set of attributes for prediction; and
predicting, by the computer system, the set of attributes for a component in the production environment using a machine learning model to predict the set of attributes for the component using a knowledge graph.

24. A method for modeling a production environment, the method comprising:
generating a knowledge graph for a component in the production environment;
selecting a set of attributes for the component from the knowledge graph;
determining a correlation value between attributes in the set of attributes for the component;
selecting the attributes in the set of attributes when the correlation value is within a correlation threshold;
combining the selected attributes in the set of attributes when the correlation value is within the correlation threshold;
repeating the determining, selecting, and combining steps for the selected attributes in the set of attributes until a number of selected attributes is within a selection threshold;
sending the number of selected attributes as an input to a model of the production environment; and
updating the model of the production environment in response to receiving the number of selected attributes.

25. The method of claim 24 further comprising:
transforming the selected attributes in the set of attributes when the correlation value is within the correlation threshold.

26. The method of claim 24 further comprising:
predicting the set of attributes for the component in the production environment using the machine learning model trained to predict the set of attributes using the knowledge graph.

27. A method for training a machine learning model for modeling a production environment, the method comprising:
generating a knowledge graph for a component in the production environment;
selecting a set of attributes for the component from the knowledge graph;
determining a correlation value between attributes in the set of attributes for the component;
selecting the attributes in the set of attributes when the correlation value is within a correlation threshold;
combining the selected attributes in the set of attributes when the correlation value is within the correlation threshold;
repeating the determining, selecting, and combining steps for the selected attributes in the set of attributes until a number of selected attributes is within a selection threshold;
creating a training dataset comprising the number of selected attributes from the knowledge graph; and
training the machine learning model using the training dataset.

28. The method of claim 27 further comprising:
predicting the set of attributes for the component in the production environment using the machine learning model trained to predict the set of attributes using the knowledge graph.
